(19) United States
(12) Patent Application Publication
(10) Pub. No.: US 2025/0246690 A1
(43) Pub. Date: Jul. 31, 2025

(54) CEMENT-BASED BATTERY AND METHOD FOR MANUFACTURING THEREOF

(71) Applicant: Ming Chi University of Technology, New Taipei City (TW)

(72) Inventors: Kun-Cheng PENG, New Taipei City (TW); Sheng-Yuan WANG, New Taipei City (TW); Li-Lun TSAI, New Taipei City (TW); Pin-Fu WANG, New Taipei City (TW); Ting-Yu WEI, New Taipei City (TW); Kun-Han LIN, New Taipei City (TW); Wen-Chang ZHANG, New Taipei City (TW)

(73) Assignee: Ming Chi University of Technology, New Taipei City (TW)

(21) Appl. No.: 18/613,087

(22) Filed: Mar. 21, 2024

(30) Foreign Application Priority Data
Jan. 31, 2024 (TW) 113103820

(51) Int. Cl. H01M 10/28; H01M 4/583; H01M 10/26; H01M 50/117; H01M 50/14; H01M 50/172; H01M 50/562

(52) U.S. Cl. CPC H01M 10/288; H01M 4/583; H01M 10/26; H01M 50/117; H01M 50/14; H01M 50/172; H01M 50/562

(57) ABSTRACT

Disclosed are a cement-based battery and a method for manufacturing thereof. The cement-based battery includes a waterproof structure, a battery body, a positive electrode, a negative electrode, and an electrolyte solution. The waterproof structure is provided with an accommodating cavity. The battery body is disposed in the accommodating cavity, and includes a cement-based body, which is obtained by curing a solid-liquid mixture, wherein the solid-liquid mixture includes cement, a first porous material, and a first effective microorganism aqueous solution. The positive electrode and the negative electrode are connected to the battery body respectively and extend out of the waterproof structure. The electrolyte solution is disposed in the accommodating cavity. Therefore, the cement-based battery can be applied to a cement building as an energy storage battery to provide power at night, during power outages or during emergencies.

### CROSS-REFERENCE TO RELATED APPLICATIONS

This application claims the priority benefit of Taiwan Patent Application Serial Number 113103820, filed on Jan. 31, 2024, the full disclosure of which is incorporated herein by reference.

### TECHNICAL FIELD OF THE INVENTION

The present disclosure relates to a battery and a method for manufacturing thereof, in particular to a cement-based battery and a method for manufacturing thereof.

### DESCRIPTION OF THE RELATED ART

The energy storage technology used in the energy transfer technology can store electrical energy in advance to provide power for the operation of electronic devices at night, during power outages or during emergencies.

If the energy storage technology is applied to a bulky building structure, the electrical energy stored in the building structure that serves as an energy storage system can be considerable. Since the cement-based material is one of the commonly used construction materials around the world, how to provide a cement-based battery has become one of the important topics.

### SUMMARY OF THE INVENTION

Embodiments of the present disclosure provide a cement-based battery and a method for manufacturing thereof. The cement-based battery can be used as an energy storage battery and applied to a cement building, so that the electrical energy stored in the structure of the cement building that serves as an energy storage system is considerable.

In order to achieve the above technical effects, the present disclosure is implemented as follows.

The present disclosure provides a cement-based battery, which includes a waterproof structure, a battery body, a positive electrode, a negative electrode, and an electrolyte solution. The waterproof structure is provided with an accommodating cavity. The battery body is disposed in the accommodating cavity, and includes a cement-based body, which is obtained by curing a solid-liquid mixture, wherein the solid-liquid mixture includes cement, a first porous material, and a first effective microorganism aqueous solution. The positive electrode and the negative electrode are connected to the battery body respectively and extend out of the waterproof structure. The electrolyte solution is disposed in the accommodating cavity.

The present disclosure provides a method for manufacturing a cement-based battery, which includes the following steps: providing a waterproof structure, the waterproof structure comprising an accommodating cavity with an opening; stirring cement, a first porous material and a first effective microorganism aqueous solution evenly to form a solid-liquid mixture; placing one end of a positive electrode and one end of a negative electrode in the solid-liquid mixture, and curing the solid-liquid mixture to obtain a battery body provided with the positive electrode and the negative electrode; placing the battery body provided with the positive electrode and the negative electrode and an electrolyte solution in the accommodating cavity, the other end of the positive electrode and the other end of the negative electrode extending out of the waterproof structure; and scaling the opening of the waterproof structure to obtain the cement-based battery.

The present disclosure provides another method for manufacturing a cement-based battery, which includes the following steps: providing a waterproof structure, the waterproof structure comprising an accommodating cavity with an opening; stirring cement, a first porous material and a first effective microorganism aqueous solution evenly to form a solid-liquid mixture; stirring a second porous material and a second effective microorganism aqueous solution evenly to form a core body; placing the core body between two layers of the solid-liquid mixture to form a sandwich stack structure; placing one end of a positive electrode and one end of a negative electrode in the sandwich stack structure, and curing the sandwich stack structure to obtain a battery body provided with the positive electrode and the negative electrode; placing the battery body provided with the positive electrode and the negative electrode and an electrolyte solution in the accommodating cavity, the other end of the positive electrode and the other end of the negative electrode extending out of the waterproof structure; and sealing the opening of the waterproof structure to obtain the cement-based battery.

In the embodiments of the present disclosure, the battery body or part of the battery body of the cement-based battery, which comprises the cement that provides structural strength, the first porous material with pores used to store and provide electrical energy, and the first effective microorganism aqueous solution that serves as a surfactant, is combined with the electrolyte solution disposed in the waterproof structure, the positive electrode and the negative electrode, to constitute the cement-based battery that can be applied to cement buildings.

### BRIEF DESCRIPTION OF DRAWINGS

Accompanying drawings described herein are intended to provide a further understanding of the present disclosure and form a part of the present disclosure, and exemplary embodiments of the present disclosure and descriptions thereof are intended to explain the present disclosure but are not intended to unduly limit the present disclosure. In the drawings:

FIG. 1 is a schematic cross-sectional view of a cement-based battery according to an embodiment of the present disclosure.

FIG. 2 is a schematic cross-sectional view of a cement-based battery according to another embodiment of the present disclosure.

FIG. 3 is a flow chart of a method for manufacturing a cement-based battery according to an embodiment of the present disclosure.

FIG. 4 is a flow chart of a method for manufacturing a cement-based battery according to another embodiment of the present disclosure.

FIG. 5 is a diagram showing discharge curves of cement-based batteries including a solid-liquid mixtures with different composition ratios.

FIG. 6 is a diagram showing discharge curves of cement-based batteries including another solid-liquid mixture with different composition ratios.

FIG. 7 is a diagram showing a discharge curve of a cement-based battery with a battery body of a sandwich stack structure.

### DETAILED DESCRIPTION OF THE INVENTION

The embodiments of the present disclosure will be described below in conjunction with the relevant drawings. In the figures, the same reference numbers refer to the same or similar components or method flows.

It must be understood that the words “including”, “comprising” and the like used in this specification are used to indicate the existence of specific technical features, values, method steps, work processes, elements and/or components. However, it does not exclude that more technical features, values, method steps, work processes, elements, components, or any combination of the above can be added.

It must be understood that when an element is described as being “connected” or “coupled” to another element, it may be directly connected or coupled to another element, and intermediate elements therebetween may be present. In contrast, when an element is described as “directly connected” or “directly coupled” to another element, there is no intervening element therebetween.

It will be understood that the terms “first”, “second”, “third”, etc. may be used to describe various elements. However, these elements are not limited by these terms; these terms are used to distinguish one element from another element.

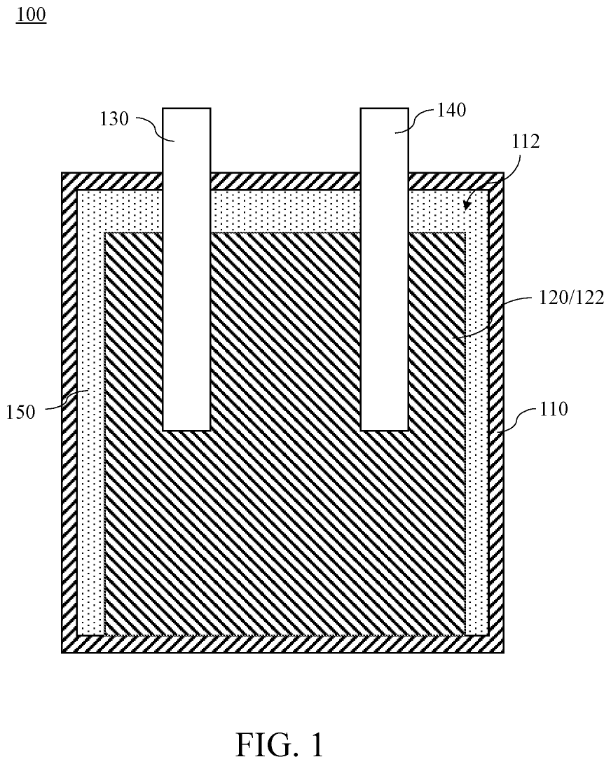

Please refer to FIG. 1, which is a schematic cross-sectional view of a cement-based battery according to an embodiment of the present disclosure. As shown in FIG. 1, a cement-based battery 100 may be used in cement buildings as an energy storage battery, and comprises a waterproof structure 110, a battery body 120, a positive electrode 130, a negative electrode 140 and an electrolyte solution 150. The waterproof structure 110 is provided with an accommodating cavity 112. The battery body 120 is disposed in the accommodating cavity 112 and comprises a cement-based body 122. The cement-based body 122 is obtained by curing a solid-liquid mixture. The solid-liquid mixture comprises cement, a first porous material and a first effective microorganism aqueous solution. The positive electrode 130 and the negative electrode 140 are respectively connected to the battery body 120 and extend out of the waterproof structure 110. The electrolyte solution 150 is disposed in the accommodating cavity 112. The waterproof structure 110 is formed by a soft waterproof film, such as an aluminum-plastic film, enclosed (i.e., the cement-based battery 100 is a soft package battery), or assembled by hard waterproof shells (i.e., the cement-based battery 100 is a hard-shell battery). The waterproof structure 110 is used to prevent the electrolyte solution 150 in the accommodating cavity 112 from seeping out. When the cement-based batteries 100 can be used in the cement building as energy storage batteries, a plurality of cement-based batteries 100 may be connected in parallel and/or in series to achieve the voltage and current required by the user.

The battery body 120 or part of the battery body 120 of the cement-based battery 100, which comprises the cement that provides structural strength, the first porous material with pores used to store and provide electrical energy, and the first effective microorganism aqueous solution that serves as a surfactant, is combined with the electrolyte solution 150 disposed in the waterproof structure 110, the positive electrode 130 and the negative electrode 140, to constitute the cement-based battery 100 that can be applied to cement buildings.

In one embodiment, the cement may comprise one or more of silicate cement, aluminate cement, sulfoaluminate cement, ferroaluminate cement, fluoroaluminate cement and phosphate cement.

In one embodiment, the first porous material may comprise one or more of activated carbon, carbon fibers, carbon nanotubes, graphene, and coffee grounds without coffee oil. The bonding between coffee grounds having coffee oil and the cement is poorer than that between coffee grounds without coffee oil and the cement, and the poor bonding will affect the structural strength of the battery body 120. Therefore, the coffee grounds can be washed with a detergent including sodium hydroxide to remove the coffee oil in the coffee grounds, thereby obtaining the coffee grounds without the coffee oil.

In one embodiment, the first effective microorganism aqueous solution may comprise effective microorganisms and water, but the embodiment is not limited thereto. In other embodiments, the first effective microorganism aqueous solution may further comprise nitrogen source and/or carbon source. For example, the first effective microorganism aqueous solution may be formed by mixing of dried effective microorganisms, such as effective microorganism powder, and water, or the first effective microorganism aqueous solution may consist of the effective microorganisms and the cultivating environment thereof, which contains water, carbon source, and nitrogen source. It should be noted that various additives, such as nutritional agents, well known by a person having ordinary skill in the art may also be added to the first effective microorganism aqueous solution of the present disclosure to maintain the survival rate of the effective microorganisms. That is, the present disclosure is not limited to the compose mentioned above.

In one embodiment, the effective microorganisms may comprise one or more of photosynthetic bacteria series, lactobacillus series, yeast series, fungus series and streptomyces series, but the embodiment is not limited thereto. For example, the lactic acid bacteria can be Lactobacillus acidophilus commonly known as A bacteria, Bifidobacterium species commonly known as B bacteria or Bifidobacterium, and Lactobacillus casei commonly known as C bacteria. In some embodiments, the effective microorganisms may consist of 80 different microorganism species, and the microorganism species may include but not be limited to the microorganisms mentioned above.

In some embodiments, the first effective microorganism aqueous solution may directly use the 5-14 liquid miscellaneous organic fertilizer with the registration number of the fertilizer system (quality) No. 0495006 (Agriculture and Food Agency Council of Agriculture, the Executive Yuan of Taiwan). More specifically, the microorganisms in the liquid miscellaneous organic fertilizer may include nitrogen fixing bacteria series, nitrifying bacteria series, phosphoric acid releasing series, photosynthetic bacteria series, Lactobacillus series, yeast series, actinobacteria series, and growth factors producing bacteria series. In addition to the microorganisms mentioned above, the liquid miscellaneous organic fertilizer may further contain molasses, urea, egg, canavanine powder, and water.

In one embodiment, a mass ratio of the first effective microorganism aqueous solution to the first porous material is from 1:1 to 1:2, but the embodiment is not limited thereto.

In one embodiment, the positive electrode 130 may be, but is not limited to, a metal sheet, and a material of the metal sheet may comprise copper, aluminum, silver, titanium alloy, or a combination thereof.

In one embodiment, the negative electrode 140 may be made of a graphite material, which may comprise graphite, carbon nanotubes, graphene, or a combination thereof, but the embodiment is not limited thereto.

In one embodiment, the positive electrode 130 and the negative electrode 140 may be disposed on the same side of the battery body 120. In another embodiment, the positive electrode 130 and the negative electrode 140 may be disposed on opposite sides of the battery body 120.

In one embodiment, the electrolyte solution 150 may be, but is not limited to, a weakly alkaline solution.

In one embodiment, the electrolyte solution 150 may be, but is not limited to, a sodium chloride solution or a potassium chloride solution, and a volumetric molar concentration of the electrolyte solution 150 may be greater than or equal to 3M.

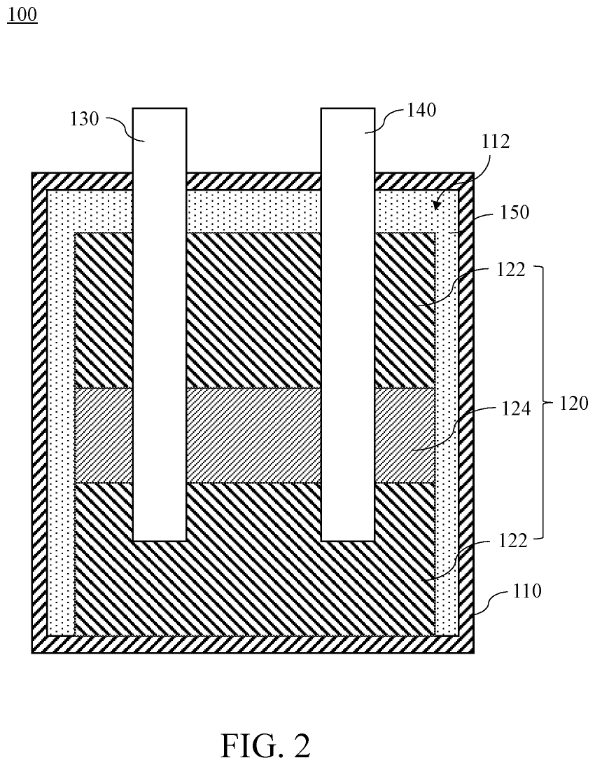

Please refer to FIG. 2, which is a schematic cross-sectional view of a cement-based battery according to another embodiment of the present disclosure. The difference between the embodiment of FIG. 2 and the embodiment of FIG. 1 is that the battery body 120 of FIG. 2 has a sandwich stack structure. Specifically, the battery body 120 may comprise two cement-based bodies 122 and a core body 124. The two cement-based bodies 122 are disposed on opposite sides of the core body 124 to form the sandwich stack structure, wherein the core body 124 may comprise a second porous material and a second effective microorganism aqueous solution. The second porous material may comprise one or more of activated carbon, carbon fibers, carbon nanotubes, graphene and coffee grounds without coffee oil. The composition of the first porous material and the composition of the second porous material may be the same or different. The second effective microorganism aqueous solution may comprise effective microorganisms and water. The composition of the first effective microorganism aqueous solution and the composition of the second effective microorganism aqueous solution may be the same or different.

In one embodiment, a mass ratio of the second porous material to the second effective microorganism aqueous solution in the core body 124 is the same as or different from a mass ratio of the first porous material to the first effective microorganism aqueous solution in the cement-based body 122.

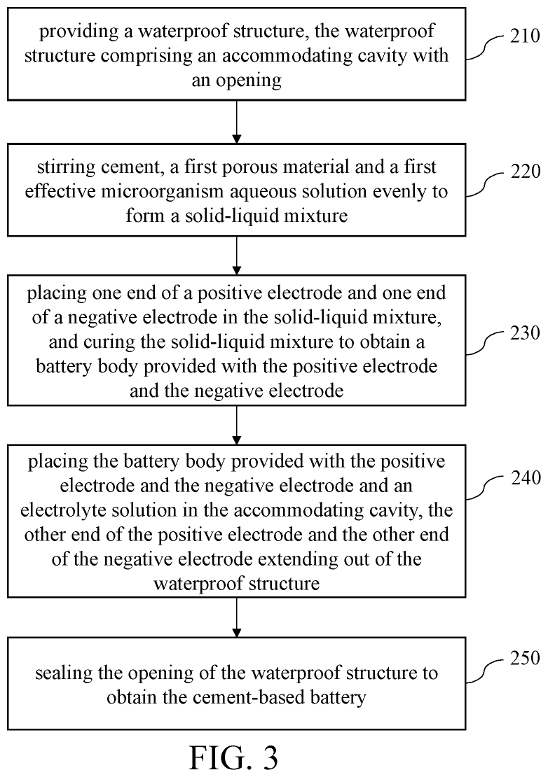

Please refer to FIG. 3, which is a flow chart of a method for manufacturing a cement-based battery according to an embodiment of the present disclosure. The method for manufacturing the cement-based battery in FIG. 3 can be adapted to manufacture the cement-based battery 100 in FIG. 1. As shown in FIG. 3, the method for manufacturing the cement-based battery may comprise the following steps: providing a waterproof structure 110, and the waterproof structure 110 comprising an accommodating cavity 112 with an opening (step 210); stirring cement, a first porous material and a first effective microorganism aqueous solution evenly to form a solid-liquid mixture (step 220); placing one end of a positive electrode 130 and one end of a negative electrode 140 in the solid-liquid mixture, and curing the solid-liquid mixture to obtain a battery body 120 provided with the positive electrode 130 and the negative electrode 140 (step 230); placing the battery body 120 provided with the positive electrode 130 and the negative electrode 140 and an electrolyte solution 150 in the accommodating cavity 112, the other end of the positive electrode 130 and the other end of the negative electrode 140 extending out of the waterproof structure 110 (step 240); and sealing the opening of the waterproof structure 110 to obtain the cement-based battery 100 (step 250).

In one embodiment, the even stirring in step 220 can be achieved by mechanical stirring, and by controlling the appropriate stirring time, the cement, the first porous material and the first effective microorganism aqueous solution are fully stirred and evenly mixed, wherein the appropriate stirring time can be adjusted based on the sum of the masses of the cement, the first porous material and the first effective microorganism aqueous solution.

In one embodiment, curing the solid-liquid mixture in step 230 may comprise curing the solid-liquid mixture by drying at room temperature. In another embodiment, curing the solid-liquid mixture in step 230 may comprise using an oven to perform forced drying to cure the solid-liquid mixture.

In one embodiment, when the cement-based battery 100 is a soft package battery, the waterproof structure 110 in step 210 can be formed by a soft waterproof film, such as an aluminum-plastic film, enclosed, thereby forming an accommodating cavity 112 with an opening; scaling the opening of the waterproof structure 110 in step 250 may comprise performing heat pressing on the soft waterproof film near the opening to form an edge seal, so that the edge seal seals the opening. In another embodiment, when the cement-based battery 100 is a hard-shell battery, the waterproof structure 110 in step 210 may comprise a cover shell and a main shell (that is, the waterproof structure 110 may be assembled by hard waterproof shells), and the main shell includes the waterproof structure 110 with an opening; sealing the opening of the waterproof structure 110 in step 250 may comprise using the cover shell to cover the opening to seal the opening, wherein an adhesive member is provided at the connection between the cover shell and the main shell to achieve scaling of the accommodating cavity 112, and the adhesive member may be glue, a tape or a hot melt adhesive.

It should be noted that the adhesive member (not shown) is also provided on the edges of the positive electrode 130 and the negative electrode 140 close to the waterproof structure 110 to prevent the electrolyte solution 150 from seeping out.

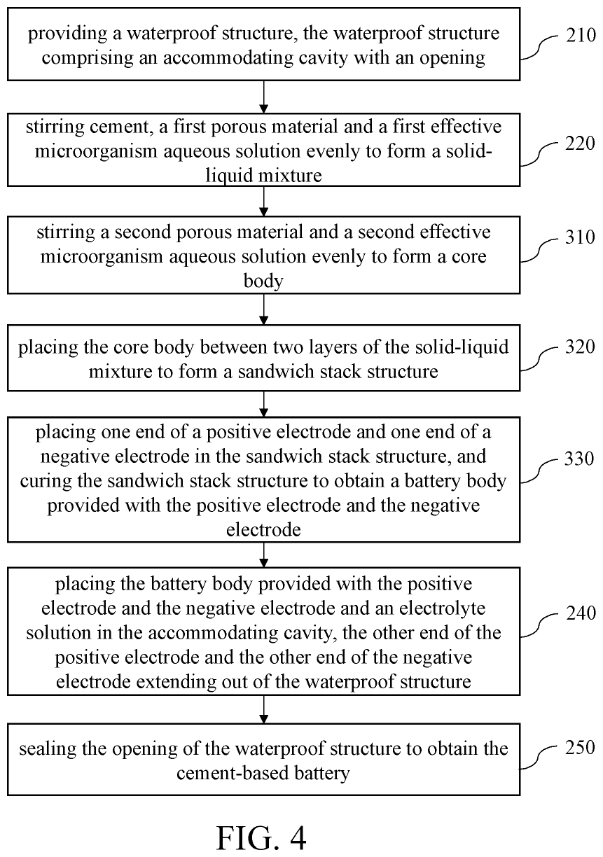

Please refer to FIG. 4, which is a flow chart of a method for manufacturing a cement-based battery according to another embodiment of the present disclosure. The method for manufacturing the cement-based battery in FIG. 4 can be adapted to manufacture the cement-based battery 100 in FIG. 2. As shown in FIG. 4, the method for manufacturing the cement-based battery may comprise the following steps: providing a waterproof structure 110, and the waterproof structure 110 comprising an accommodating cavity 112 with an opening (step 210); stirring cement, a first porous material and a first effective microorganism aqueous solution evenly to form a solid-liquid mixture (step 220); stirring a second porous material and a second effective microorganism aqueous solution evenly to form a core body 124 (step 310); placing the core body 124 between two layers of the solid-liquid mixture to form a sandwich stack structure (step 320); placing one end of a positive electrode 130 and one end of a negative electrode 140 in the sandwich stack structure, and curing the sandwich stack structure to obtain a battery body 120 provided with the positive electrode 130 and the negative electrode 140 (step 330); placing the battery body 120 provided with the positive electrode 130 and the negative electrode 140 and an electrolyte solution 150 in the accommodating cavity 112, the other end of the positive electrode 130 and the other end of the negative electrode 140 extending out of the waterproof structure 110 (step 240); and sealing the opening of the waterproof structure 110 to obtain the cement-based battery 100 (step 250).

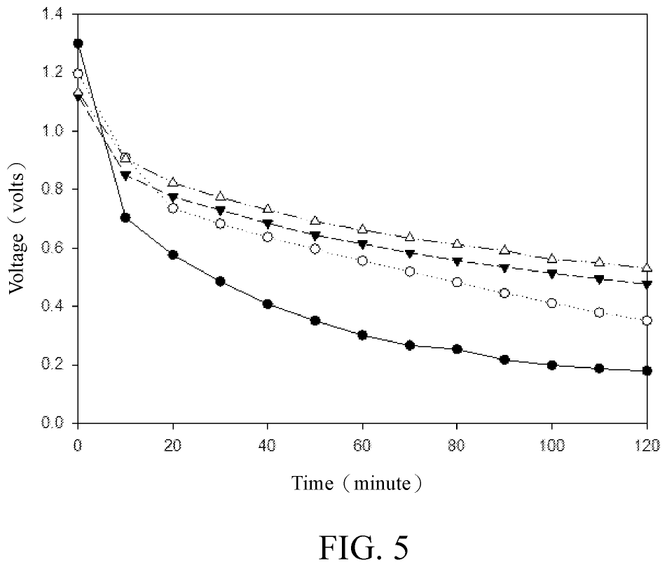

Please refer to FIG. 5, which is a diagram showing discharge curves of cement-based batteries including a solid-liquid mixtures with different composition ratios. As shown in FIG. 5, the solid line with black circles is the discharge curve of the cement-based battery with the solid-liquid mixture comprising 120 grams of cement, 15 grams of activated carbon, 15 grams of the first effective microorganism aqueous solution and 50 grams of water; the solid line with white circles is the discharge curve of the cement-based battery with the solid-liquid mixture comprising 100 grams of cement, 20 grams of activated carbon, 20 grams of the first effective microorganism aqueous solution and 60 grams of water; the solid line with black triangles is the discharge curve of the cement-based battery with the solid-liquid mixture comprising 100 grams of cement, 30 grams of activated carbon, 30 grams of the first effective microorganism aqueous solution and 40 grams of water; the solid line with white triangles is the discharge curve of the cement-based battery with the solid-liquid mixture comprising 50 grams of cement, 50 grams of activated carbon, 50 grams of the first effective microorganism aqueous solution and 50 grams of water; a material of the negative electrode of the cement-based battery is graphite, the positive electrode of the cement-based battery is a copper sheet; the electrolyte solution is a potassium chloride solution with a volumetric molar concentration of 3M; and the cement-based battery discharges after charging with a current of 0.05 amperes for 3 hours. It can be seen from FIG. 5 that as the mass of activated carbon increases, the voltage of the cement-based battery drops relatively slowly during the discharge process, and the voltage of the cement-based battery after two hours of discharge is relatively high. It should be noted that the above charging current of 0.05 amperes and charging time of 3 hours are defined based on the internal resistance of the cement-based battery and/or the mass of the solid-liquid mixture, and the actual charging current and charging time can be adjusted based on the internal resistance of the cement-based battery and/or the mass of the solid-liquid mixture to avoid overheating during charging.

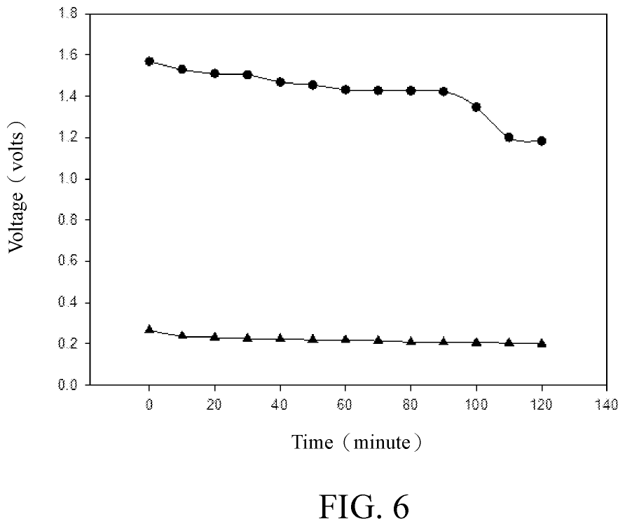

Please refer to FIG. 6, which is a diagram showing discharge curves of cement-based batteries including another solid-liquid mixture with different composition ratios. As shown in FIG. 6, the solid line with triangles is the discharge curve of the cement-based battery with the solid-liquid mixture comprising 140 grams of cement, 10 grams of coffee grounds without coffee oil, and 30 grams of the first effective microorganism aqueous solution; the solid line with circles is the discharge curve of the cement-based battery with the solid-liquid mixture comprising 120 grams of cement, 30 grams of coffee grounds without coffee oil, and 30 grams of the first effective microorganism aqueous solution; a material of the negative electrode of the cement-based battery is graphite, and the positive electrode of the cement-based battery is copper sheet; the electrolyte solution is a potassium chloride solution with a volumetric molar concentration of 3M; and the cement-based battery discharges after charging with a current of 0.03 amperes for 3 hours. It can be seen from FIG. 6 that as the mass of coffee grounds without coffee oil increases, the voltage of the cement-based battery during the discharge process is relatively high. In addition, it can be seen from FIGS. 5 and 6 that during the discharge process, the voltage stability of the cement-based battery with the first porous material of coffee grounds without coffee oil is higher than that of the cement-based battery with the first porous material of activated carbon.

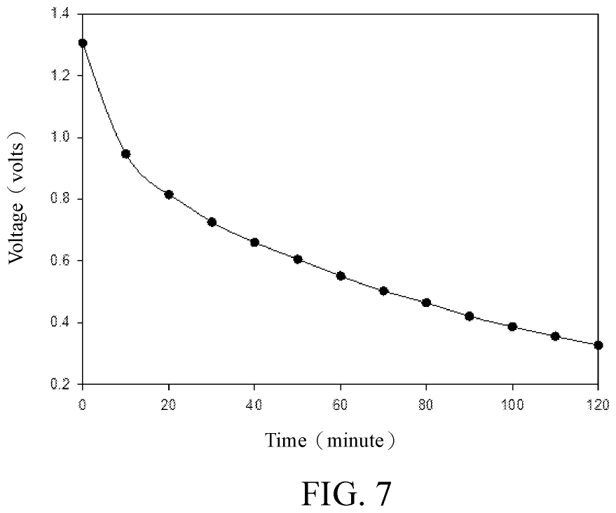

Please refer to FIGS. 5 and 7, wherein FIG. 7 is a diagram showing a discharge curve of a cement-based battery with a battery body of a sandwich stack structure. After the solid-liquid mixture comprising 100 grams of cement, 20 grams of activated carbon, 20 grams of the first effective microorganism aqueous solution and 60 grams of water is stirred evenly and then divided into two equal parts, and the core body comprising 20 grams of activated carbon and 20 grams of the second effective microorganism aqueous solution is stirred evenly, the core body is disposed between the two equal parts of the solid-liquid mixture to form a sandwich stack structure, wherein the mass ratio of the second porous material to the second effective microorganism aqueous solution in the core body is the same as the mass ratio of the first porous material to the first effective microorganism aqueous solution in the cement-based body. The line with circles in FIG. 7 is the discharge curve of the cement-based battery with the battery body of the aforementioned sandwich stack structure, the aforementioned cement-based battery has the negative electrode of graphite and the positive electrode of copper sheet, the electrolyte solution is a potassium chloride solution with a volumetric molar concentration of 3M, and the cement-based battery discharges after charging with a current of 0.05 amperes for 3 hours. When the masses of the activated carbon and the first effective microorganism aqueous solution included in the solid-liquid mixture are both 20 grams, the cement-based battery with the battery body of the sandwich stack structure in FIG. 7 and the cement-based battery including a single cement-based body in FIG. 5 have the same discharge effect.

To sum up, in the embodiments of the present disclosure, the battery body or part of the battery body of the cement-based battery, which comprises the cement that provides structural strength, the first porous material with pores used to store and provide electrical energy, and the first effective microorganism aqueous solution that serves as a surfactant, is combined with the electrolyte solution disposed in the waterproof structure, the positive electrode and the negative electrode, to constitute the cement-based battery that can be applied to cement buildings. As a result, the electrical energy stored in the structure of the cement building that serves as an energy storage system is considerable. When the cement-based batteries can be used in the cement building as energy storage batteries, a plurality of cement-based batteries can be connected in parallel and/or in series to achieve the voltage and current required by the user.

While the present disclosure is disclosed in the foregoing embodiments, it should be noted that these descriptions are not intended to limit the present disclosure. On the contrary, the present disclosure covers modifications and equivalent arrangements obvious to those skilled in the art. Therefore, the scope of the claims must be interpreted in the broadest manner to comprise all obvious modifications and equivalent arrangements.

1. A cement-based battery, comprising:
a waterproof structure with an accommodating cavity;
a battery body disposed in the accommodating cavity and comprising a cement-based body obtained by curing a solid-liquid mixture, wherein the solid-liquid mixture comprises cement, a first porous material, and a first effective microorganism aqueous solution;
a positive electrode and a negative electrode connected to the battery body respectively and configured to extend out of the waterproof structure; and
an electrolyte solution disposed in the accommodating cavity.

2. The cement-based battery according to claim 1, wherein a mass ratio of the first effective microorganism aqueous solution to the first porous material is from 1:1 to 1:2.

3. The cement-based battery according to claim 1, wherein the first porous material comprises activated carbon, carbon fibers, carbon nanotubes, graphene, coffee grounds without coffee oil, or a combination thereof.

4. The cement-based battery according to claim 1, wherein the battery body comprises two cement-based bodies and a core body, the two cement-based bodies are disposed on opposite sides of the core body to form a sandwich stack structure, and the core body comprises a second porous material and a second effective microorganism aqueous solution.

5. The cement-based battery according to claim 4, wherein a mass ratio of the second porous material to the second effective microorganism aqueous solution in the core body is the same as or different from a mass ratio of the first porous material to the first effective microorganism aqueous solution in the cement-based body.

6. The cement-based battery according to claim 1, wherein the first effective microorganism aqueous solution comprises effective microorganisms and water, and the effective microorganisms comprise one or more of photosynthetic bacteria series, lactobacillus series, yeast series, fungus series, and actinobacteria series.

7. The cement-based battery according to claim 1, wherein the electrolyte solution is a weakly alkaline solution.

8. The cement-based battery according to claim 7, wherein the electrolyte solution is a sodium chloride solution or a potassium chloride solution, and a volumetric molar concentration of the electrolyte solution is greater than or equal to 3M.

9. The cement-based battery according to claim 1, wherein the electrolyte solution is a sodium chloride solution or a potassium chloride solution, and a volumetric molar concentration of the electrolyte solution is greater than or equal to 3M.

10. The cement-based battery according to claim 1, wherein the negative electrode is made of a graphite material, and the graphite material comprises graphite, carbon nanotubes, graphene, or a combination thereof.

11. The cement-based battery according to claim 1, wherein the positive electrode is a metal sheet, and a material of the metal sheet comprises copper, aluminum, silver, titanium alloy, or a combination thereof.

12. A method for manufacturing a cement-based battery, comprising the following steps:
providing a waterproof structure, the waterproof structure comprising an accommodating cavity with an opening;
stirring cement, a first porous material and a first effective microorganism aqueous solution evenly to form a solid-liquid mixture;
placing one end of a positive electrode and one end of a negative electrode in the solid-liquid mixture, and curing the solid-liquid mixture to obtain a battery body provided with the positive electrode and the negative electrode;
placing the battery body provided with the positive electrode and the negative electrode and an electrolyte solution in the accommodating cavity, the other end of the positive electrode and the other end of the negative electrode extending out of the waterproof structure; and
sealing the opening of the waterproof structure to obtain the cement-based battery.

13. A method for manufacturing a cement-based battery, comprising the following steps:
providing a waterproof structure, the waterproof structure comprising an accommodating cavity with an opening;
stirring cement, a first porous material and a first effective microorganism aqueous solution evenly to form a solid-liquid mixture;
stirring a second porous material and a second effective microorganism aqueous solution evenly to form a core body;
placing the core body between two layers of the solid-liquid mixture to form a sandwich stack structure;
placing one end of a positive electrode and one end of a negative electrode in the sandwich stack structure, and curing the sandwich stack structure to obtain a battery body provided with the positive electrode and the negative electrode;
placing the battery body provided with the positive electrode and the negative electrode and an electrolyte solution in the accommodating cavity, the other end of the positive electrode and the other end of the negative electrode extending out of the waterproof structure; and
sealing the opening of the waterproof structure to obtain the cement-based battery.
